(19) United States
(12) Patent Application Publication
(10) Pub. No.: US 2002/0141680 A1
(43) Pub. Date: Oct. 3, 2002

(54) System and method for measurement of PMD over wavelength

(76) Inventors: Eric T. Green, Corning, NY (US); James A. Smith, Painted Post, NY (US); Donald J. Sobiski, Horseheads, NY (US)

Correspondence Address: CORNING INCORPORATED, SP-TI-3-1, CORNING, NY, 14831

(21) Appl. No.: 09/785,642

(22) Filed: Feb. 16, 2001

(51) Int. Cl. G02B 6/27; G02B 6/00

(52) U.S. Cl. 385/11; 385/136

(57) ABSTRACT

A system for compensating polarization mode dispersion of optical signals in an optical transmission line. The device includes first and second optical lines and a polarization splitter adapted to be operably connected to an optical transmission line. The polarization splitter is configured to split the principle states of polarization of an optical signal from the optical transmission line into first and second optical signal components that travel along the first and second optical lines, respectively. The device includes a stretcher that is configured to selectively vary the length of at least a selected one of the first and second optical lines. A controller is operatively connected to the stretcher, and controls the stretcher to compensate for polarization mode dispersion present in the optical transmission line. The device also includes an optical output line and a polarization combiner operatively connected to the first and second optical lines. The polarization combiner is adapted to combine the polarized optical signal components into an optical signal and route the output signal to the optical output line.

### CROSS-REFERENCE TO RELATED APPLICATIONS

This application is to be filed simultaneously with U.S. patent application under attorney docket number SP01-008 entitled “Adaptive Feedback Control Techniques for Polarization Mode Dispersion or Chromatic Dispersion Compensator” inventors being D. Sobiski and M. Whiting and hereto this same day to be filed simultaneously as U.S. patent application under attorney docket number SP00-055 entitled “Electric Detector for Adaptive Control of Chromatic Dispersion in Optical Systems” name inventors being C. Henning and D. Sobiski and U.S. patent application under attorney docket number SP01-022Of entitled “System and Method for Measurement of the State of Polarization Over Wavelength” inventor D. Chowdury being which are all hereby incorporated by reference.

### BACKGROUND OF THE INVENTION

1. Field of the Invention

The present invention generally relates to optical communication systems, and particularly to a method and apparatus for compensating for polarization mode dispersion (PMD) in optical systems.

2. Technical Background

PMD in optical fibers is a recognized source of bit errors in modern high bit-rate optical communication systems. PMD causes pulse broadening and/or deformation, and thereby imposes an upper limit on the bit-rate that can be used in a given system. The upper limit is

### TECHNICAL BACKGROUND

PMD in optical fibers is a recognized source of bit errors in modem high bit-rate optical communication systems. PMD causes pulse broadening and/or deformation, and thereby imposes an upper limit on the bit-rate that can be used in a given system. The upper limit is reached when the pulse has broadened sufficiently so that it interferes with neighboring pulses. As the pulses continue to smear into each other, the individual bits can no longer be distinguished, inter-symbol interference occurs, and the communication network fails.

In the theoretical field, Poole and Wagner (“Phenomenological Approach to Polarisation Dispersion in Long Single-mode Fibres, Electronics Letters, volume 22, pp.1029-1030, 1986”) introduced a model for polarization mode dispersion in interconnected single-mode fibers based on the principle states of polarization (PSP). The PSP's in interconnected fiber are equivalent to the polarization axes in a single span of fiber. Polarized light that is launched into the fiber in alignment with the two polarization axes, or the PSP's will exit the fiber with that polarization unchanged. The broadening induced by first order PMD is caused by the propagation time difference between the input pulse projections onto each of the two polarization axes in a single span of fiber, or onto the PSP's in interconnected fiber. This time difference is called differential group delay (DGD), and is usually measured in picoseconds. The group property of delay for the fiber is referred to as PMD (polarization mode dispersion), and is expressed in units of picoseconds per kilometer for a single span fiber, and in picoseconds per square root kilometer, for interconnected spans of fiber.

Various optical arrangements have been proposed as possible PMD compensators. Examples of such arrangements are disclosed in U.S. Pat. No. 5,793,511 and U.S. Pat. No. 5,822,100. Known PMD compensators require one or more polarization rotators capable of transforming an arbitrary input polarization state into a predetermined output state. Known compensators also utilize a method of compensating for the dispersion caused by DGD. Accordingly, the different PMD compensator arrangements can be classified according to the principle used for the polarization transformation and for the compensation. In general, the polarization transformation can be accomplished using mechanically rotated elements (see e.g., R. Noé, D. Sandel, M. Yoshida-Dierolf, S. Hinz, C. Glingener, C. Scheerer, A. Schöpflin and G. Fischer, “Polarization Mode Dispersion Compensation at 20 Gbit/s with Fiber-based Distributed Equaliser, Electronics Letters, volume 34, 1998”), liquid crystals (see e.g., S. H. Rumbaugh, M. D. Jones and L. W. Casperson, “Polarization Control for Coherent Fiber-optic Systems Using Nematic Liquid Crystals, J. Lightwave Technol., volume 8, pp. 459-465, 1990”), or fiber squeezing (see e.g., R. Noé, H. Heidrich and D. Hoffmann, “Endless Polarization Control Systems for Coherent Optics, J. Lightwave Technol., volume 6, pp. 1199-1208, 1988”). Squeezing of an optical fiber induces a stress birefringence which can be utilized to control polarization. Existing PMD compensator designs may consist of optical or opto-electronic birefringent elements that permit the delay of one polarization state with respect to the other. However, known PMD compensators may not permit rapid adjustment to compensate for changes in the PMD occurring in the system during operation, and also may not provide the desired degree of accuracy and dependability required of a commercial fiber optics base communication system.

### SUMMARY OF THE INVENTION

One aspect of the present invention is a device for compensating for polarization mode dispersion of optical signals in an optical transmission line. The device includes first and second optical lines and a polarization splitter adapted to be operably connected to an optical transmission line. The polarization splitter splits an optical signal from the optical transmission line into first and second optical signal components that travel along the first and second optical lines, respectively. The device includes a stretcher that selectively varies the length of at least a selected one of the first and second optical lines. A controller is operatively connected to the stretcher, and controls the stretcher to compensate for polarization mode dispersion present in the optical transmission line. The device also includes an optical output line and a polarization combiner operatively connected to the first and second optical lines. The polarization combiner is adapted to combine the polarized optical signal components into an optical signal and route the output signal to the optical output line.

Another aspect of the present invention is a device for stretching an optical fiber. The device includes a base and a pair of support members that receive a fiber coil thereon. At least a selected one of the support members is rigidly mounted on the base and defines a distance between the support members. At least a selected one of the support members is translationally mounted to the base such that the distance between the support members can be selectively varied. An actuator is operatively connected to at least a selected one of the hubs to selectively vary the distance based, at least in part, upon signals from an associated controller.

Yet another aspect of the present invention is a method for compensating for polarization mode dispersion of an optical signal in an optical transmission line. The method includes splitting an optical signal from the optical transmission line into first and second polarized signal components. The first polarized signal component is routed along a first optical line, and the second polarized signal component is routed along a second optical line. The length of at least a selected one of the first and second optical lines is varied to reduce the dispersion of the first and second polarized components. The first and second polarized signals are then combined into an output signal.

Yet another aspect of the present invention is a communication system including an optical transmitter, an optical receiver, and an optical transmission line operably interconnecting the optical transmitter and the optical receiver. The communication system further includes a device operably connected to the optical transmission line for compensating for polarization mode dispersion of optical signals in the optical transmission line. The device includes first and second optical lines and a polarization splitter operably connected to an optical transmission line. The polarization splitter splits an optical signal from the optical transmission line into first and second optical signal components that travel along the first and second optical lines, respectively. The device includes a stretcher that selectively varies the length of at least a selected one of the first and second optical lines. A controller is operatively connected to the stretcher, and controls the stretcher to compensate for polarization mode dispersion present in the optical transmission line. The device also includes an optical output line and a polarization combiner operatively connected to the first and second optical lines. The polarization combiner combines the polarized optical signal components into an optical signal and routes the output signal to the optical output line.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention, which, together with their description serve to explain the principals and operation of the invention.

### BRIEF DESCRIPTION OF THE DRAWINGS

FIG. 1 is a diagram in block and schematic form of a fiber optics communication system including a polarization mode dispersion compensator of the present invention;

FIG. 2 is a perspective view of a fiber stretcher utilized in the polarization mode dispersion compensator of FIG. 1;

FIG. 3 is a perspective view of the fiber stretcher of FIG. 2 with several components shown in phantom to illustrate the piezoelectric force cell and related components;

FIG. 4A is a cross-sectional view of the fiber stretcher taken along the line IV-IV; FIG. 2;

FIG. 4B is a partially schematic view of a second embodiment of the fiber stretcher of FIG. 1; and

FIG. 5 is a block diagram of the PMD detector of FIG. 1.

### DETAILED DESCRIPTION OF THE PREFERRED EMBODIMENT

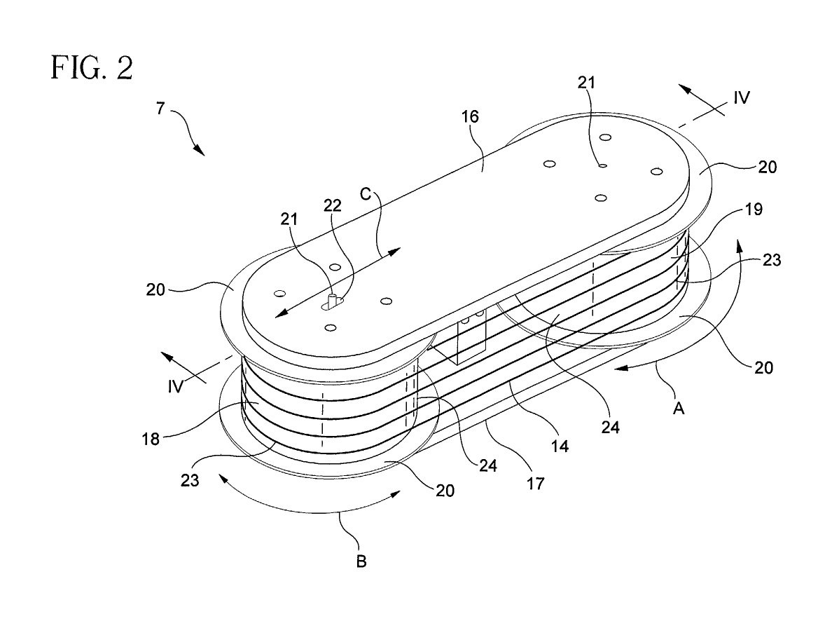

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

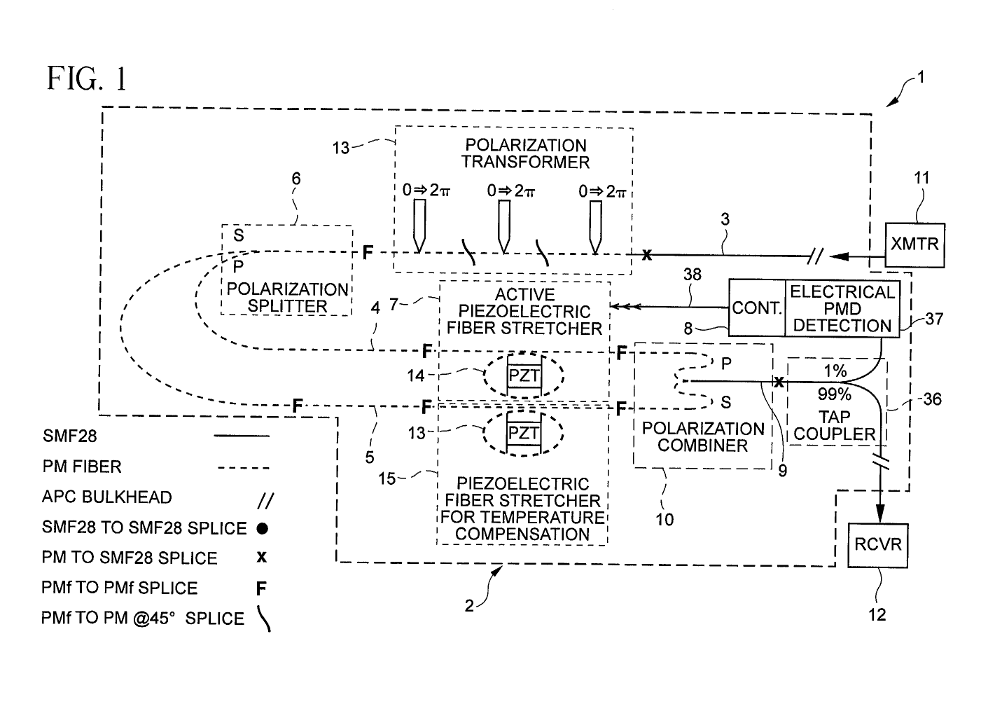

Referring initially to FIG. 1, there is shown a communication system 1 embodying the present invention. In the illustrated example, the optical communication system 1 includes a transmitter 11 and a receiver and an optical transmission line 3 with a device 2 disposed therebetween for compensating for polarization mode dispersion of optical signals in an optical transmission line 3. The device 2 includes a first optical line 4 and a second optical line 5. A polarization splitter 6 is adapted to be operably connected to the optical transmission line 3, and the polarization splitter 6 is configured to split an optical signal from the optical transmission line 3 into first and second optical signal components having different polarizations and traveling along the first and second optical lines 4, and 5, respectively. A stretcher 7 selectively varies the length of at least a selected one of the first optical line 4 and the second optical line 5. A controller 8 is coupled to the stretcher 7, and controls the stretcher 7 to compensate for polarization mode dispersion present in the optical transmission line 3. A polarization combiner 10 is coupled to the first and second optical lines 4 and 5 and combines the polarized optical signal components into an output signal and routes the output signal to an optical output line 9.

The polarization mode dispersion compensating device 2 includes a polarization transformer 13 that is connected to the optical transmission line 3. In the preferred embodiment, the first optical line 4 and the second optical line 5 each comprise polarization maintaining fibers to maintain the polarization state input by the polarization splitter 6. The polarization transformer 13 rotates the principle states of polarization PSP into the S and P polarizations of the polarization maintaining fibers 4 and 5. The polarization transformer 13 is described in detail in pending U.S. application Ser. No. 09/589,423, entitled ALL FIBER POLARIZATION MODE DISPERSION COMPENSATOR, filed on Jun. 7, 2000, the entire contents of which are hereby incorporated herein by reference. The S and P polarizations of the signal light are then split into separate optical paths (corresponding to the optical lines 4 and 5) by the polarization splitter. The P polarized signal travels beyond the polarization splitter and the optical line 4 and into the fiber stretcher 7. The fiber stretcher 7 stretches a loop 14 (see FIG. 2) of fiber to add or subtract optical path length so that the arrival time for the S and P polarized signals at the receiver 12 is the same.

A second (“passive”) fiber stretcher 15 is utilized in the second optical line 5 carrying the S polarized signal to compensate for thermal expansion variations and index changes in the first fiber stretcher 7 due to ambient temperature fluctuations. Thus, the optical path length variation due to changes in temperature in the stretcher 7 will be nearly identical to the length changes in the second stretcher 15. When the S polarized signal exits the second stretcher 15, the polarization combiner 10 combines the S polarized signal with the compensated P polarized signal.

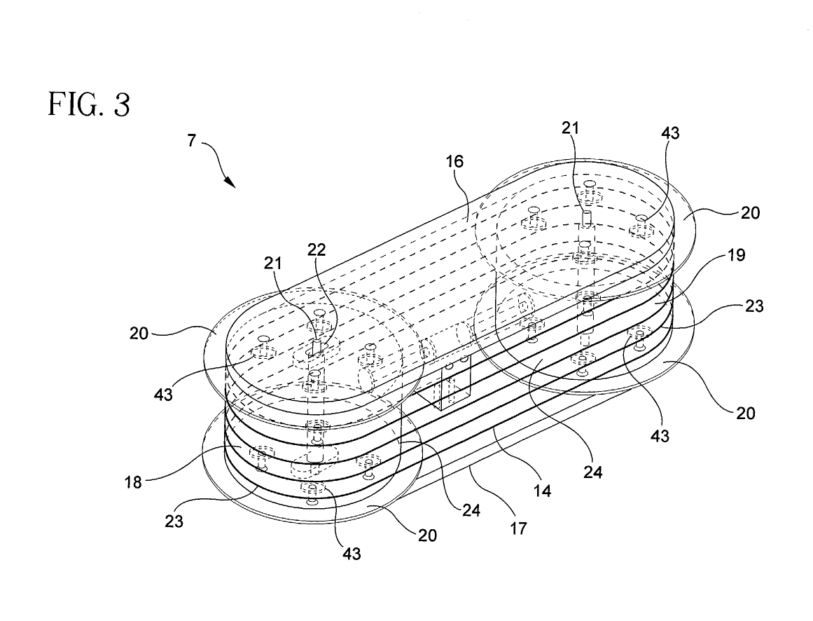

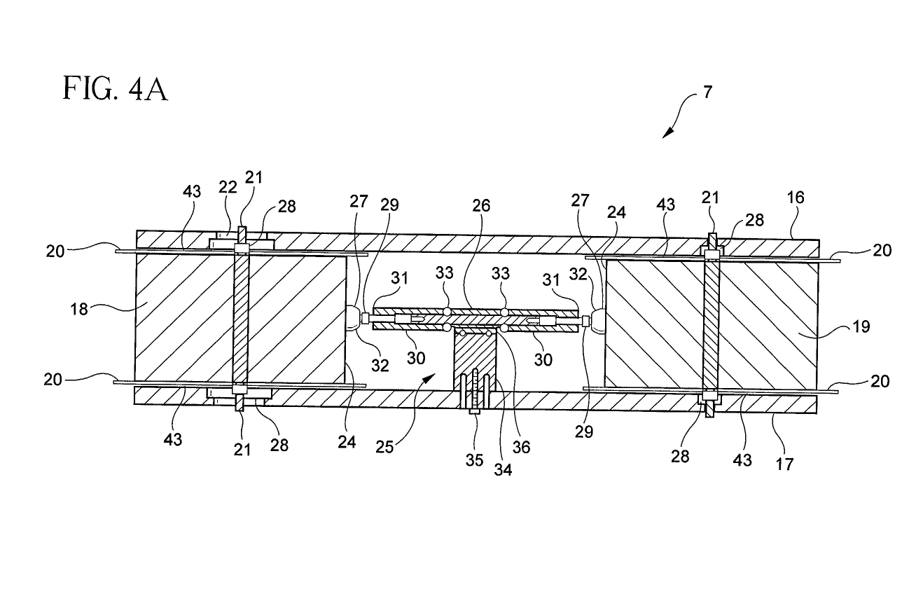

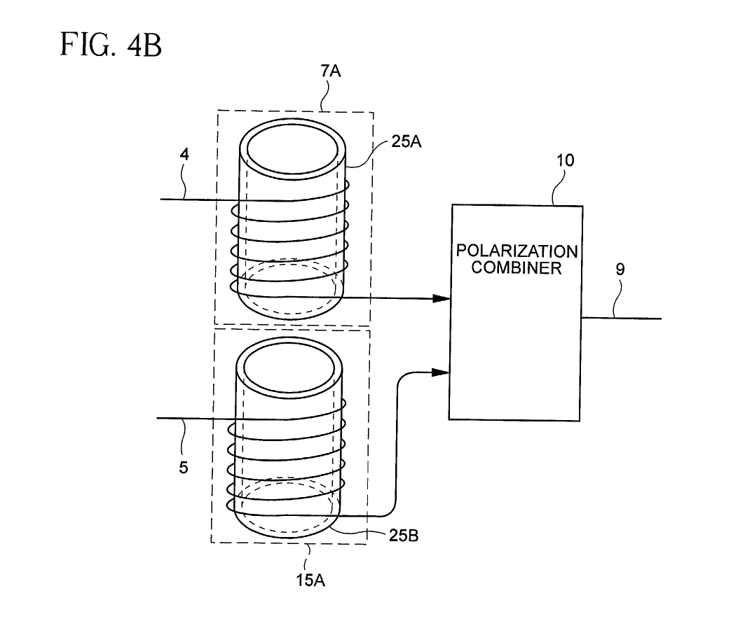

The fiber stretchers 7 and 15 have substantially the same construction, such that only the first stretcher 7 will be described in detail herein. With further reference to FIGS. 2-4, the fiber stretcher 7 includes first and second hubs 18 and 19 that are mounted between an upper plate 16 and lower plate 17. Hubs 18 and 19 includes flanges 20 to retain the loop of fiber 14 on the hubs. The spindle 21 of first hub 18 is received in a pair of slots 22 located in the upper and lower plates 16 and 17, such that the first spindle can rotate as indicated by the arrow “B”, and also translates linearly as indicated by the arrow “C”. The spindle 21 of the second hub 19 is rotatably mounted between the plates 16 and 17, and permits rotation as indicated by the arrow “A” (FIG. 2). However, the second hub 19 does not translate linearly with respect to the plates 16 and 17. The hubs 18 and 19 include a substantially cylindrical outer wall 23 that supports the fiber loop 14. The hubs 18 and 19 also include substantially flat surfaces 24 that face and are generally parallel to one another. An actuator assembly 25 (FIG. 4A) includes a piezoelectric force cell or actuator 26, and pads 27 that contact the flat surfaces 24 of hubs 18 and 19. A controlled voltage is delivered to the piezoelectric force cell 26 to precisely vary the length of the force cell 26 and the spacing of the first hub 18 relative to the second hub 19. The length change of the piezoelectric force cell 26 is thereby transferred to the fiber loop 14. The first and second hubs 18 and 19 are preferably mounted to the plates 16 and 17 by ball bearings 28 to facilitate rotation and translation of the hubs 18 and 19 during operation. A plurality of ball bearings 43 having a small ring-like race are secured to plates 16 and 17 to provide a low friction interface between hubs 18, 19 and plates 16, 17.

The piezoelectric actuator assembly 25 includes a pair of threaded members 29 that are threadably received into the ends of sleeves 30. Threaded members 29 are connected to the pads 27 by a ball-and-socket joint 32 to provide for angular misalignment that may occur between the components during assembly. The forces generated by the piezoelectric force cell 26 are transferred to the sleeves 30 through thrust bearings 33 that rotationally decouple the force cell 26 from the sleeves 30. The threaded members 29 may be rotated relative to the sleeves 30 to provide a preload on the fiber loop 14. The force applied to the fiber loop 14 may be monitored by measuring the voltage output of the piezoelectric force cell 26 during such adjustment. A support member 34 is secured to the plate 17 by a threaded fastener 35. Support member 34 includes a V-groove 36 that supports and positions the piezoelectric force cell 26.

After the P-polarized signal exits the stretcher 7, it is combined with the S polarized signal in the polarization combiner 10 (FIG. 1), and the combined signal travels to the receiver 12. A small fraction (e.g. 1 percent) of the combined signal is tapped off and monitored by an electrical PMD detector 37. A control signal 38 is generated by the controller 8, and controls the stretcher 7 to dynamically adjust the time delay in the optical path to compensate for the PMD that would otherwise be present.

As discussed above, the fiber 14 looped around the hubs 18 and 19 of stretcher 7 is stretched during operation to alter the optical path difference between the S and P polarizations traveling through the fibers 5 and 4. The time change resulting from the change of length of the fibers may be expressed as follows:

$$Δ t = \frac{n Δ L}{C} \{ 1 - \frac{{n}^{2}}{2} [ {p}_{12} - υ ( {p}_{11} + {p}_{12} ) ] \}$$

Where

Δt=time delay

n=index of refraction

ΔL=change in length of the fiber

C=speed of light

P₁₁=strain-optic coefficient

P₁₂=strain-optic coefficient

υ=Poisson's ratio

For example, the time delay caused by stretching a section of SMW 28 TM fiber by 4 cm is 124 ps. Equation 1 takes into account the fact that the index of refraction decreases slightly when tensile stress is applied to a fiber. A change of refraction effectively decreases the optical path length change and hence decreases the actual time delay. If a 0.5 km length of fiber is wound on the fiber stretcher 7 with a total perimeter of 0.31 m, the piezoelectric force cell 26 would need to change by 4 um to provide a fiber length change of 4 cm in the fiber. Controller 8 is programmed to generate a signal 38 to stretcher 7 to change the length of fiber loop 14 the needed amount to generate a time delay sufficient to compensate for the PMD detected by detector 37.

The fiber stretchers 7 and 15 may be designed for a variety of applications. The following is an example of one such design for illustrative purposes. To determine length and number of fiber coils required, assuming 4 cm length change with an initial length of ˜500 m, and an actuator travel of 30 μm:

4 cm=40 mm ==40,000 μm change in length

40,000 μm/30 μm=1333 fiber segments to be strained

1333/2=667 fiber coils

500 m=500,000 mm initial fiber length

500,000 mm/667=750 mm perimeter per coil

To determine diameter and center-to-center dimensions of fiber hubs, assuming use of 400 μm fiber:

P=π(D+0.4)+2X, where:

P=coil perimeter from previous calculation (mm)

D=diameter of fiber hub (mm)

X=center-to-center distance between hubs (mm)

750=π(D+0.4)+4D (assuming X=2D)

750=πD+1.2566+4D

750−1.2566=(π+4)D

748.7434=(π+4)D

D=748.7434/(π+4)

D=104.84 mm

X=2D

X=209.69 mm

To determine height of fiber hubs, assuming 400 μm fiber:

H=0.4N, where:

N=number of coils from previous calculation

H=0.4(667)

H=267mm

To determine force (GPa) to strain fiber, assuming 400 μm fiber but assume 100% of the load is carried by the glass fiber since tensile strength of fused silica>>polymer coating: cladding diameter=125 μm

F=2N*(πr²)*S*ΔL/L, where:

F=Force (GPa)

N=Number of coils

r=Radius of fiber cross-section (mm)

S=Tensile strength of fused silica (GPa)

ΔL=Desired length change (mm)

L=Initial length (mm)

F=(2N*(π*0.0625²)*(70.3)*40)/500,000

F=(2*667*π*0.0625²*70.3*40)/500,000

F=46,032/500,000

F=0.092 GPa=92 MPa

It is noted that other types of structures may also be utilized. For example, FIG. 4B illustrates schematically fiber stretchers 7A and 15A. More specifically, the linear PZT (piezoelectric) actuator and hubs of stretchers 7 and 15 may be replaced by single cylinders 25A and 25B made from a PZT material. The fiber is wound around these cylinders, and the diameters of the cylinders 25A and 25B can be changed by applying a voltage to the PZT material. Thus, the fiber looped around the cylinder can be stretched by the appropriate amount by application of voltage. In the illustrated example, fiber stretchers 7A and 15A have a diameter of about 4 inches, a length of about 3 inches, and a wall thickness of about 0.20 inches. Various types of piezoelectric cylinders of known construction are available, such as those available from Edo Electro-Ceramic Products of Salt Lake City, Utah.

Thus, the stretchers 7 and 15 can be readily designed to meet the requirements of a wide variety of applications utilizing the design equations described above.

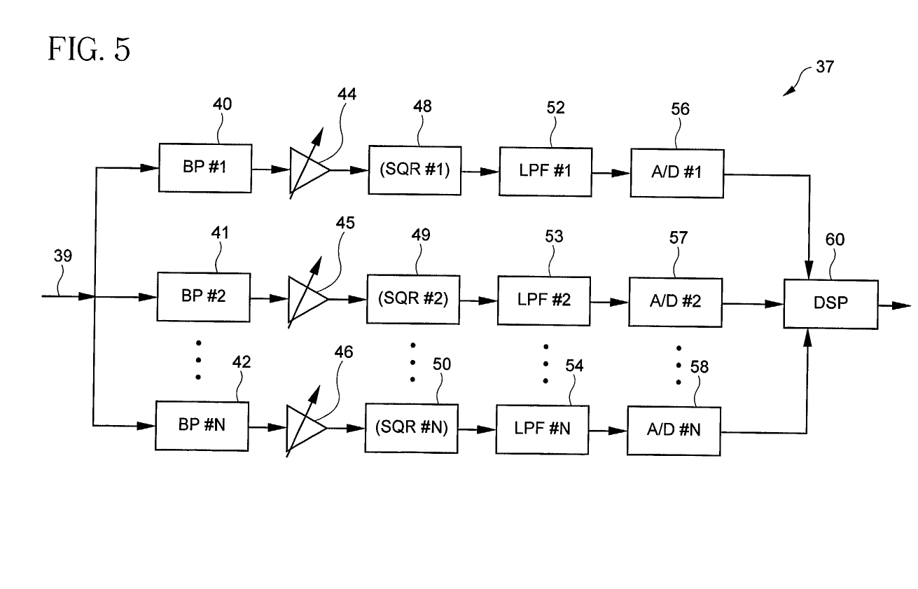

FIG. 5 is a block diagram illustrating the exemplary PMD detector 37 of FIG. 1. Other types of PMD detectors may also be utilized. The reference numeral 39 designates an incoming signal from the optical line 9, wherein the signal 39 has been converted to an electrical signal. The blocks 40, 41, and 42 are narrow bandpass filters that are spaced such that at least three of the center frequencies are within the bandwidth of the incoming signal. Variable gain amplifiers 44-46 are set manually, but it is anticipated that amplifiers 44-46 could be coupled to receive control signals from controller 8 for automatic gain control to keep the circuits balanced as signal power levels change. The blocks 48, 49, and 50 are square-law detectors whose transfer function is characterized by V_{OUT}=V_{IN}². In other words, the voltage out is equal to the square of the voltage in. This detector is directly proportional to the power in the received signal near the center frequency of the preceding bandpass filter. The blocks marked 52, 53, and 54 are lowpass filters that smooth the output of the square-law detectors such that the output is near direct current when compared to the center frequencies of the bandpass filters. The blocks numbered 56, 57, and 58 are analog to digital converters that sample and convert the input voltages to a binary word that can be processed in the digital signal processor (DSP) 60. The DSP 60 is a computing device that can perform digital signal processing. The DSP reconstructs a measure of the amount of PMD that is present in the received signal, and this measurement is suitable for processing in a dynamic feedback control algorithm to provide for compensation of PMD.

The device operates on the principle that the time domain properties and the frequency domain properties of the communications signal are related by Parseval's law, which states that

the power in the signal over time is equal to the power in the signal over frequency, e.g., given a time series signal v(t):

$$Power = \frac{1}{{T}_{0}} {\int }_{0}^{{T}_{0}} \vert {v}^{2} ( t ) \vert ⅆ t = {\sum }_{n = - ∞}^{∞} \vert {c}_{n}^{2} \vert$$

where cₙ are the coefficients of a Fourier expansion for v(t):

$${c}_{n} = \frac{1}{{T}_{0}} {\int }_{0}^{{T}_{0}} v ( t ) {ⅇ}^{- j ax} ⅆ t ; n = 1 , 2 , 3 , …$$

The time domain properties are manifested in the spreading of the pulse due to the PMD.

As illustrated in FIG. 1, the PMD detector 37 and controller 8 utilize a closed feedback structure. The controller 8 is programmed to generate a control signal 38 according to the following algorithm. According to the following algorithm, controller 8 generates commands that are sent to the stretcher 7 that are proportional to the gradient of the DGD, which is the rate of change of the detector output. Using the gradient as the basis for the command decouples the compensator command from the bias introduced by the addition of other, independent sources of dispersion. Because the control signal changes in a monotonic fashion with the changes in the dispersion in the system, the gradient can be reliably computed as an indication of the direction of change of the amount of dispersion in the signal. A general equation to approximate this gradient is at time tₖ, given a sequence of n+1 measurements of dispersion ƒ(tⱼ): taken at the time tⱼ<=tₖ is to evaluate the following equation:

gradient(tₖ)=Σⱼ₌₀ⁿƒ(tⱼ)L^{t}ⱼ(tⱼ)

where L^{t}ⱼ(tⱼ) is the derivative of the j^{th} order Lagrange polynomial. The Lagrange polynomial can be computed with the following equation:

$${L}_{j} ( {t}_{j} ) = {\prod }_{{i = 0}_{i \neq j}}^{n} \frac{( t - {t}_{i} )}{( {t}_{j} - {t}_{i} )}$$

The error in the gradient computation will remain bounded for all time.

The steps utilized in the controlled algorithm are as follows:

1. Using the detector, take a measurement of the current dispersion.

2. Command the fiber stretcher 7 to take a small step to reduce the dispersion.

3. Take a new measurement of the dispersion.

4. Compute the gradient of the dispersion.

5. IF the gradient is negative. THEN decide if the size of the step needs to be changed, and then repeat steps 2, 3, and 4. ELSE

6. IF the gradient is positive OR zero, THEN command the fiber stretcher 7 to return to its previous position because dispersion from the other source is present or it cannot be adjusted because of the split ratio for PMD.

7. Command the fiber stretcher 7 to take small step to increase the dispersion.

8. Take new measurement of the dispersion.

9. Compute the gradient of the dispersion.

10. IF the gradient is negative, THEN decide if the size of the step needs to be changed, and then repeat steps 7, 8, and 9, ELSE

11. IF the gradient is positive OR zero, THEN command the fiber stretcher 7 to return to its previous position because dispersion from the other source is present or it cannot be adjusted because of the split ratio for PMD.

Steps 1-11 are repeated continuously. Adaptation occurs automatically in the algorithm if the magnitude of the gradient changes. If the gradient becomes larger than the current gradient, the controller command will increase in magnitude, and if the gradient becomes smaller than the current gradient, the controller command will decrease in magnitude. Additionally, the algorithm will be bounded input-bounded output stable, provided the bandwidth of the controller hardware exceeds that of the dynamics of the signal. This provides for adequate phase margin to compensate for time delays and system latencies. This stability can be seen by noting that the controller commands that will change the amount of dispersion in the signal are given by the following equation:

$$Dispersion ( {t}_{k} ) = \{ \begin{matrix} Dispersion ( {t}_{k - 1} ) & if gradient ( {t}_{k} ) >= 0 \\ Dispersion ( {t}_{k - 1} ) - step * compensator & if gradient ( {t}_{k} ) < 0\end{matrix}$$

Because the dispersion in the system can never increase due to the actions commanded by the controller, the system will be bounded input-bounded output stable.

In operation, the controller 8 adjusts the fiber stretcher 7 until no further decrease in dispersion can be accomplished, and then continuously tries to adjust the fiber stretcher 7, keeping the dispersion at a minimum.

The stretched fiber PMD compensator of the present invention provides a dynamic PMD compensation for correcting first order PMD in fiber optic communication systems.

It will become apparent to those skilled in the art that various modifications to the preferred embodiment of the invention as described herein can be made without departing from the spirit or scope of the invention as defined by the appended claims.

The invention claimed is:

1. A system for compensating for polarization mode dispersion of optical signals in an optical transmission line, comprising:
a polarization splitter for coupling to an optical transmission line;
first and second optical lines coupled to the polarization splitter to split an optical signal from an optical transmission line into first and second optical signal components that travel along the first and second optical lines, respectively;
a stretcher coupled to at least one of the first and second optical lines to selectively vary the length of at least a selected one of the first and second optical lines;
a controller operatively connected to the stretcher for controlling the stretcher to compensate for polarization mode dispersion present in the optical transmission line;
an optical output line; and
a polarization combiner coupled to the first and second optical lines to combine the polarized optical signal components into an output signal and route the output signal to the optical output line.

2. The system for compensating for polarization mode dispersion of claim 1, including:
a polarization mode dispersion detector adapted to be operably connected to a selected one of the optical output line and an associated optical transmission line to provide an input to the controller.

3. The system for compensating for polarization mode dispersion of claim 2, wherein:
the polarization mode dispersion detector is coupled to the optical output line.

4. The system for compensating for polarization mode dispersion of claim 1, wherein:
the stretcher includes a pair of hubs having a fiber coil thereon, the stretcher further including an actuator operatively interconnecting the hubs to selectively vary the distance therebetween to selectively stretch the fiber coil.

5. The system for compensating for polarization mode dispersion of claim 4, wherein:
the first and second optical lines comprise polarization maintaining fibers; and including:
a polarization transformer operatively connected to the polarization splitter, the polarization transformer configured to transform an arbitrary input polarization state of an associated optical transmission line into a predetermined output state wherein the principle states of polarization are aligned with the polarization axes of the first and second optical lines.

6. The system for compensating for polarization mode dispersion of claim 5, wherein:
the output state includes an S polarization axis that is routed through the first optical line, and a P polarization axis that is routed through the second optical line, the second optical line disposed on the hubs of the stretcher to form the fiber coil.

7. The system for compensating for polarization mode dispersion of claim 6, wherein:
the stretcher comprises a first stretcher, and including:
a second stretcher having a pair of hubs, the second stretcher configured to selectively vary the length of the first optical line based at least in part upon ambient temperature fluctuations.

8. The system for compensating for polarization mode dispersion of claim 7, wherein:
the first and second stretchers each include a piezoelectric force cell operatively connected to at least a selected one of the hubs to shift the selected one of the hubs upon actuation of the piezoelectric force cell.

9. The system for compensating for polarization mode dispersion of claim 6, wherein:
the stretcher includes a housing;
the pair of hubs comprises first and second hubs defining a distance therebetween, the first hub being rotationally mounted to the housing, the second hub being rotationally and translationally mounted to the housing; and
a piezoelectric force cell operatively interconnecting the first and second hubs to selectively vary the distance between the first and second hubs.

10. A device for stretching an optical fiber, comprising:
a base;
a pair of support members for receiving a fiber coil thereon, at least a selected one of the support members rotationally mounted on the base and defining a distance between the support members, at least a selected one of the support members being translationally mounted to the base such that the distance between the support members can be selectively varied; and
an actuator operatively connected to at least a selected one of the hubs to selectively vary the distance.

11. The device for stretching optical fiber of claim 10, wherein:
the support members comprise hubs having curved outer surfaces configured to support a fiber coil looped around the hubs.

12. The device for stretching optical fiber of claim 11, wherein:
both hubs are both rotationally mounted to the base member;
the actuator comprises a piezoelectric actuator extending between the hubs and generating a force tending to increase the distance between the hubs upon actuation of the piezoelectric actuator.

13. The device for stretching optical fiber of claim 12, wherein:
the piezoelectric actuator interconnects the hubs in a manner permitting preload to be applied to a fiber coil looped around the hubs.

14. The device for stretching optical fiber of claim 13, wherein:
the base includes a pair of spaced apart plates, the hubs disposed between the plates.

15. The device for stretching optical fiber of claim 14, wherein:
each of the hubs include a spindle; and
each of the plates includes an elongated slot receiving the spindles to rotationally and translationally mount at least a selected one of the hubs.

16. The device for stretching optical fiber of claim 15, wherein:
the hubs include generally planar opposed surfaces;
the piezoelectric actuator having opposite ends, each having a pad contacting the planar opposed surfaces to generate a force thereon, each pad including a ball and socket joint to allow for misalignment of the planar opposed surfaces.

17. A method of compensating for polarization mode dispersion of an optical signal in an optical transmission line, comprising:
splitting an optical signal from the optical transmission line into first and second polarized signal components having dispersion;
routing the first polarized signal component along a first optical line;
routing the second polarized signal component along a second optical line;
varying the length of at least a selected one of the first and second optical lines to reduce the dispersion of the first and second polarized components; and
combining the first and second polarized signal components into an output signal.

18. The method of claim 17, wherein:
the optical signal is split into the principle states of polarization prior to routing of the polarization components along the first and second optical lines; and
the first and second optical lines comprise first and second polarization maintaining fibers, respectively.

19. The method of claim 18, wherein:
the length of the first polarization maintaining fiber is varied by a mechanical stretcher.

20. The method of claim 19, wherein:
a detector is utilized to measure the polarization mode dispersion of the output signal, and the detector generates a control signal to the mechanical stretcher.

21. The method of claim 20, wherein:
a polarization transformer is utilized to align the principle states of polarization of an optical signal in the optical transmission line with the S and P axes of the first and second optical lines prior to splitting of the optical signal.

22. The method of claim 21, wherein:
the length of the first optical line is varied to compensate for the polarization mode dispersion of the optical signal in the optical transmission line; and
the length of the second optical line is varied to compensate for changes in temperature affecting the first optical line.

23. A communication system, comprising:
an optical transmitter;
an optical receiver;
an optical transmission line interconnecting the optical transmitter and the optical receiver;
a compensator coupled to the optical transmission line for compensating for polarization mode dispersion of optical signals in the optical transmission line, the compensator including:
a polarization splitter coupled to the optical transmission line;
first and second optical lines coupled to the polarization splitter to split an optical signal from the optical transmission line into first and second optical signal components that travel along the first and second optical lines, respectively;
a stretcher coupled to at least one of first and second optical lines to selectively vary the length of at least a selected one of the first and second optical lines;
a controller operatively connected to the stretcher for controlling the stretcher to compensate for polarization mode dispersion present in the optical transmission line;
an optical output line; and
a polarization combiner coupled to the first and second optical lines to combine the polarized optical signal components into an output signal and route the output signal to the optical output line.
